(19) United States
(12) Patent Application Publication
(10) Pub. No.: US 2008/0054018 A1
(43) Pub. Date: Mar. 6, 2008

(54) Liquid dispenser with associated refill unit

(76) Inventors: Jeffrey James Stechschulte, Cincinnati, OH (US); Sarah Louise Thielman, Cincinnati, OH (US); Philip Andrew Sawin, Cincinnati, OH (US); Joshua James Norman, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/512,828

(22) Filed: Aug. 30, 2006

(51) Int. Cl. B05B 11/00; B67D 5/06; B65D 88/54; G01F 11/00

(52) U.S. Cl. 222/78; 222/183; 222/325; 222/321.1

(57) ABSTRACT

A liquid dispenser and associated liquid refill unit are provided. The liquid dispenser and associated liquid refill unit may be configured such that refilling of the liquid dispenser is generally limited to refilling by the associated liquid refill unit that is provided.

### FIELD OF THE INVENTION

This invention relates generally to a liquid dispenser and associated liquid refill unit and, more particularly, to a liquid dispenser and associated liquid refill unit configured such that refilling of the liquid dispenser is generally limited to refilling by the associated liquid refill unit.

### BACKGROUND

Liquid products are sold and used for a variety of applications. For example, liquid products may be sold in consumer, medical, commercial, industrial, and other contexts. Many of these liquid products are provided or used in dispensers. Some dispensers may be intended to be disposable after a single use, while others may be intended to be reused or refilled in a limited or indefinite fashion. Examples of liquid products that are provided or used in dispensers include, but are not limited to, soaps, shampoos, detergents, disinfectants, cleansers, hairspray, make-up, lotions, oils, scents, ointments, creams, antiperspirants, coloring products, medicines, skin care products, etc. For example, it is common to purchase a hand soap dispenser having soap provided therein, where the consumer disposes of the soap dispenser after the soap has been consumed. In some cases, refillable liquid dispensers may be provided, such as to reduce waste and manufacturing costs, or to make it more economically feasible to provide a sturdier or more attractive display.

Where dispensers may be refilled, it may be desirable to limit the sources of liquid that may be used to refill the dispenser. Specifically, it may be desirable to limit the refilling of a dispenser so that only the type of liquid that was supplied in the dispenser originally may be used to refill the dispenser. For example, where a manufacturer sells a dispenser with its own brand of liquid soap, if the dispenser is refilled with a product of lesser quality, users of the product may associate the characteristics of the lesser quality soap that was used to refill the dispenser with the brand of soap identified on the dispenser's label. The manufacturer may want to avoid this result. Moreover, controlling the sources of liquid that may be used to refill a dispenser may aid in the proper operation of the dispenser. Controlling the sources of liquid that may be used to refill a dispenser also may help a manufacturer to predict costs, expenses, and anticipated profits more accurately. Further, limiting the refilling of the dispenser to the type of liquid originally supplied in the dispenser mitigates any risk of refilling the dispenser with potentially hazardous products, for example a bleach-based cleaner. Particularly where the dispenser originally contains a product for young children, it may be desirable to limit refilling of the dispenser to products thus suited for young children.

Thus, a need exists for a liquid dispenser and associated liquid refill unit wherein refilling of the liquid dispenser is generally limited to refilling by the associated liquid refill unit.

### SUMMARY

A liquid dispenser and associated liquid refill unit are provided.

In one embodiment, the liquid dispenser has lock and the refill unit has a key. The liquid dispenser is refilled by fitting the key into the lock and transferring contents of the refill unit into the liquid dispenser.

In another embodiment, the liquid dispenser comprises a container and a pump, the pump having a dipstick. The refill unit is configured for receipt by the container of the liquid dispenser. The liquid dispenser is refilled by fitting the refill unit into the container and extending the dipstick into the refill unit.

In a further embodiment, the liquid dispenser comprises a pump having a dipstick and a refill unit comprising a flexible top portion and a bottom portion. The pump is received by the top portion with the dipstick extending into the bottom portion.

While multiple embodiments are disclosed, still other embodiments of the invention will become apparent to those skilled in the art from the following detailed description, which shows and describes illustrative embodiments of the invention. As will be realized, the invention is capable of modifications in various obvious aspects, all without departing from the spirit and scope of the invention. Accordingly, the drawings and detailed description are to be regarded as illustrative in nature and not restrictive.

### BRIEF DESCRIPTION OF THE DRAWINGS

FIG. 1a illustrates a liquid dispenser in accordance with one embodiment of the present invention.

FIG. 1b illustrates a liquid dispenser having an indicator in accordance with one embodiment of the present invention.

FIG. 1c illustrates a lock for the liquid dispenser of FIG. 1b.

FIG. 1d illustrates a first key for a refill unit for refilling the liquid dispenser of FIG. 1b.

FIG. 1e illustrates a second key for a refill unit for refilling the liquid dispenser of FIG. 1b.

FIG. 1f illustrates a third key for a refill unit for refilling the liquid dispenser of FIG. 1b.

FIG. 1g illustrates a fourth key for a refill unit for refilling the liquid dispenser of FIG. 1b.

FIG. 2 illustrates a refill unit for use with the liquid dispenser of FIG. 1a in accordance with one embodiment of the present invention.

FIG. 3 illustrates the dispenser of FIG. 1a being refilled with the refill unit of FIG. 2.

FIG. 4 illustrates the refill unit of FIG. 2 in an initial configuration in accordance with one embodiment of the present invention.

FIG. 5 illustrates the refill unit of FIG. 4 being configured for use in accordance with one embodiment of the present invention.

FIG. 6 illustrates a liquid dispenser in accordance with an alternative embodiment of the present invention.

FIG. 7 illustrates a refill unit for use with the liquid dispenser of FIG. 6 in accordance with one embodiment of the present invention.

FIG. 8 illustrates a liquid dispenser and refill unit in accordance with yet another embodiment of the present invention.

FIG. 9 illustrates a liquid dispenser and refill unit in accordance with a further embodiment of the present invention.

FIG. 10 illustrates a liquid dispenser and refill unit, the liquid dispenser and refill unit having generally corresponding configurations, in accordance with another embodiment of the present invention.

FIG. 11 illustrates the liquid dispenser and refill unit of FIG. 10 in a configuration for use.

FIG. 12 illustrates a liquid dispenser and refill unit, the liquid dispenser and refill unit having corresponding configurations and the liquid dispenser being of a clamshell-type design, in accordance with another embodiment of the present invention.

FIG. 13 illustrates the liquid dispenser of FIG. 12.

FIG. 14 illustrates the liquid dispenser and refill unit of FIG. 12 being configured for use in accordance with one embodiment of the present invention.

FIG. 15 illustrates a liquid dispenser and refill unit in accordance with a further embodiment of the present invention.

FIG. 16 illustrates the refill unit of FIG. 15.

FIG. 17 illustrates link refills for use with the embodiments of FIGS. 1a-7.

FIG. 18 illustrates a close up of a refill unit lock of the embodiments of FIGS. 1a-7.

FIG. 19 illustrates a refill unit in accordance with a further embodiment.

FIG. 20 illustrates the refill unit of FIG. 19 being coupled to a pump.

FIG. 21 illustrates the refill unit and pump of FIG. 20.

FIG. 22 illustrates the refill unit and pump of FIGS. 20 and 21 with the pump being depressed.

FIG. 23 illustrates a liquid dispenser and refill unit, the liquid dispenser and refill unit having corresponding configurations, in accordance with a further embodiment of the present invention.

FIG. 24 illustrates the liquid dispenser and refill unit of FIG. 23 in a configuration for use.

### DETAILED DESCRIPTION OF THE DRAWINGS

A liquid dispenser and associated liquid refill unit are provided. More particularly, a liquid dispenser and associated liquid refill unit configured such that refilling of the liquid dispenser is generally limited to refilling by the associated liquid refill unit is provided.

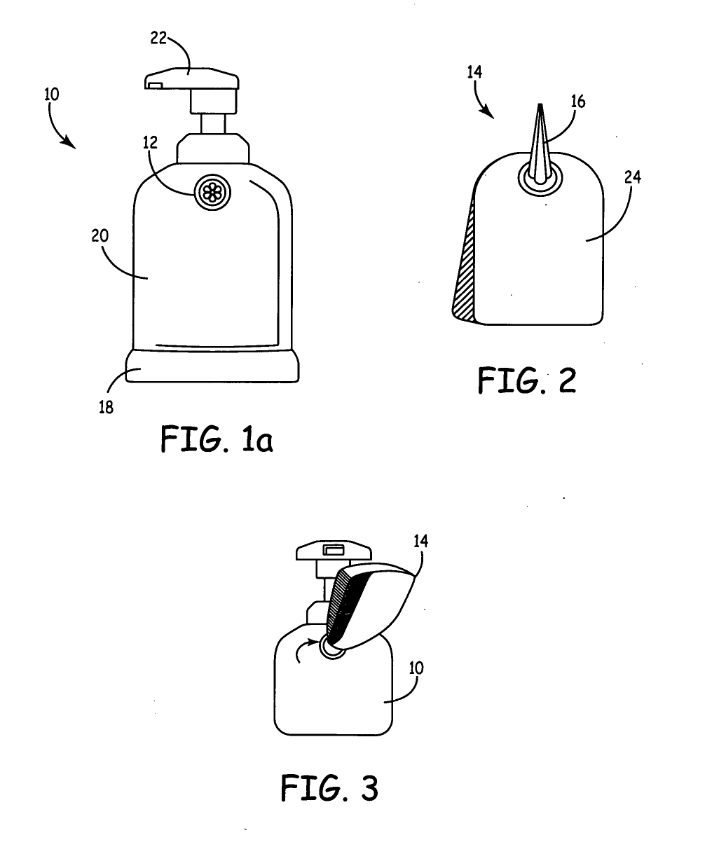

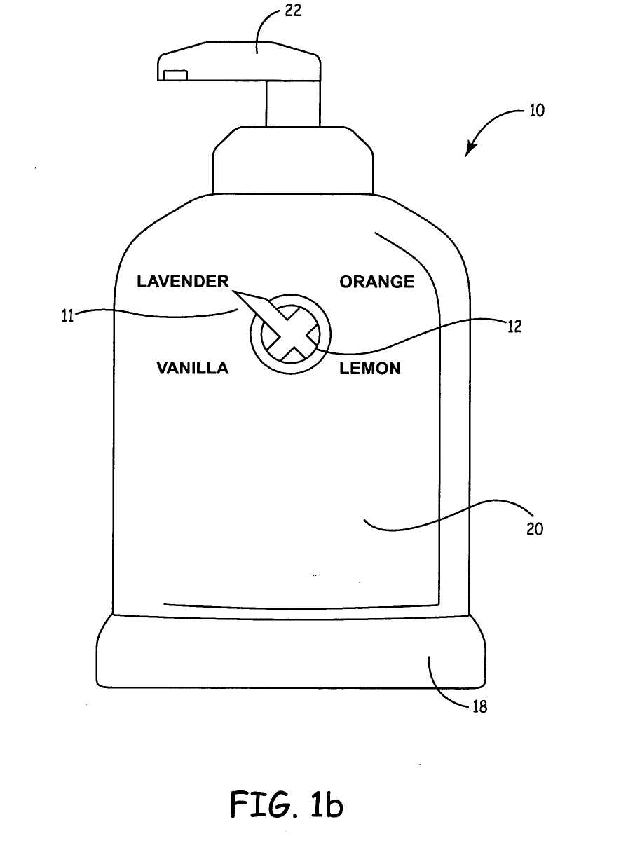

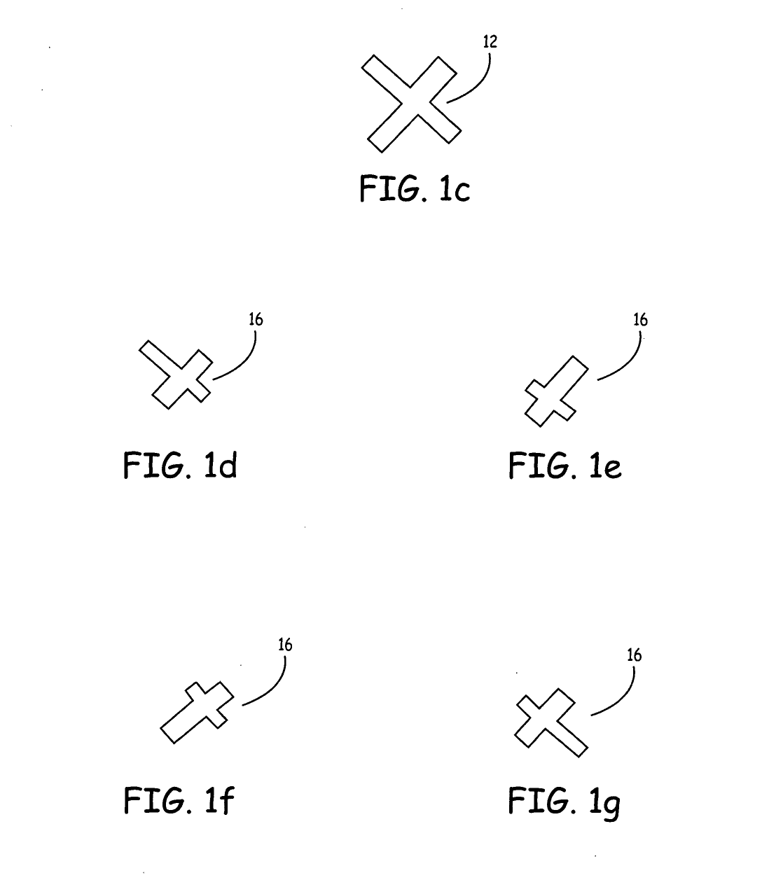

In accordance with one embodiment, a liquid dispenser having a lock and an associated liquid refill unit having a key are provided. FIG. 1a illustrates a liquid dispenser 10 having a lock 12, FIG. 2 illustrates a liquid refill unit 14 having a key 16, and FIG. 3 illustrates the liquid refill unit 14 fit with the liquid dispenser 10 to refill the dispenser 10. The size, shape, and configuration of the liquid dispenser 10 and the refill unit 14 may vary. In the embodiment shown, the liquid dispenser 10 and the refill unit 14 have generally corresponding volumes. The refill unit 14 may have a volume greater than, smaller than, or generally the same as that of the liquid dispenser 10. For example, a single refill unit 14 may be used to refill the liquid dispenser 10 multiple times and, thus, the refill unit 14 may be larger than the liquid dispenser 10. In addition, each of the liquid dispenser 10 and the refill unit 14 may be of any desired shapes. The shapes of the liquid dispenser 10 and the refill unit 14 may be generally the same, or they may differ to any desired extent. For example, it may be desirable to make one of the liquid dispenser 10 and the refill unit 14 more ornamental and the other more functional in configuration. As shown in one embodiment, a refill unit 14 may be used to refill the liquid dispenser 10 and then be disposed of. Alternatively, as will be described below, the refill unit 14 itself may be refilled.

As shown in FIGS. 1a-3, the liquid dispenser 10 and the refill unit 14 have reciprocally shaped lock 12 and key 16, respectively. To refill the liquid dispenser 10 using the refill unit 14, the key 16 of the refill unit 14 may be inserted into the lock 12 of the liquid dispenser 10. Thus, the key 16 of the refill unit 14 is shaped to be received by the lock 12 of the liquid dispenser 10. In the embodiment shown, the key 16 and lock 12 are generally star shaped. However, it is to be appreciated that any suitable reciprocal shapes may be used. For example, ovals, circles, rectangles, trapezoids, triangles, cones, squares, spirally shaped, rectangles, quadrilaterals, pentagons, hexagons, septagons, octagons, nonagons, decagons, parallelograms, rhombuses, trapeziums, alphabet letters, trademarks, logos, random shapes, eccentric shapes, irregular shapes, or other shapes may be used. In addition, any suitable numbers of locks and keys may be used. For example, it may be desirable to have two locks and keys, each of which may be correspondingly inserted so that the refill unit may refill the dispenser.

The liquid dispenser 10, the refill unit 14, the lock 12, and the key 16 may be manufactured of any suitable material. In one embodiment, the liquid dispenser 10 is manufactured of a relatively hard polymeric material while the refill unit 14 is manufactured of a flexible polymeric material. Thus, the refill unit 14 may be squeezed or otherwise manipulated to transfer its contents into the liquid dispenser after the key has been fit into the lock. In other embodiments, the liquid dispenser 10 may be made of a flexible material, or any other suitable material. In still other embodiments, the refill unit 14 may be made of a less flexible material, and a mechanism, including but not limited to a pump or dial mechanism, may be used to remove contents from the refill unit 14 into the liquid dispenser 10.

As shown in FIG. 1a, the liquid dispenser 10 comprises a base 18, a reservoir or container 20, a lock 12, and a pump 22. The lock 12 is provided on the container 20 of the liquid dispenser 10. In the embodiment shown, the lock 12 is provided at an upper portion of the container 20. Such positioning may be useful insofar as gravity aids the distribution of liquid from the refill unit 14 through the container 20. However, the lock 12 may be provided in alternative positions on the container 20. For example, the lock 12 may be provided in a visible or in an inconspicuous position on the container 20. The lock 12 may be configured to be functional in nature, ornamental in nature, or some combination of both. The base 18 provides a stable foundation for the liquid dispenser 10 such that the liquid dispenser 10 may be positioned upright. The base 18 may be integral to the container 20 or may be separate from and coupled to the container 20. The pump 22 may be a conventional pump, or any other suitable pump or structure, for a dispensing a liquid. For example, the pump 22 may include a dipstick for insertion into the liquid to be dispensed. In some embodiments, the pump 22 may be permanently coupled to the container 20 such that the container 20 is not refillable through an orifice typically filled by the pump. In alternative embodiments, the pump 22 may be removable from the container via, for example, a threaded connection.

In one embodiment, the pump 22 and lock 12 may have reciprocal shapes such that the pump dipstick is fit into the lock 12 during dispensing of the liquid from the dispenser 10. More specifically, the dipstick of the pump 22, or a sheath around the dipstick of the pump, may have a complementary shape to the lock 12. Thus, in embodiments wherein the lock 12 is star-shaped, the pump dipstick may have a generally star-shaped profile for receipt by the lock 12. In this embodiment, to refill the dispenser 10, the pump 22 is removed from the container 20 and the key 16 of the refill unit 14 is inserted in its place. In various embodiments, the key 16 of the refill unit 14 may lock into place in the lock 12 of the dispenser 10, or it may be fit loosely into the lock 12 of the dispenser 10. The contents of the refill unit 14 may be transferred, in whole or in part, into the liquid dispenser 10. After refilling is complete to the desired level, the refill unit 14 is removed by removing the key 16 from the lock 12, and the pump 22 is reinserted.

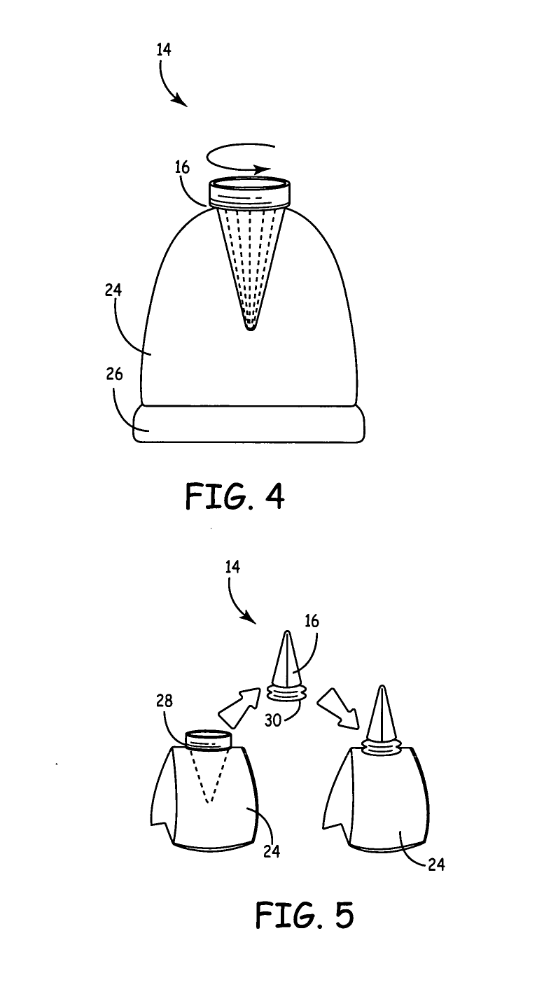

FIGS. 2, 4, and 5 illustrate one embodiment of a refill unit 14. The refill unit 14 may comprise a base 26, a pouch 24, and a key 16. In alternative embodiments, no base may be provided. As shown in FIG. 4, in its initial configuration, the key 16 may be provided generally internal of the pouch 24. Thus, in one embodiment, the pouch 24 includes an opening 28 for receiving the key 16 and the key 16 includes a base 30 for coupling with the opening 28. The opening 28 and the base 30 may be threaded such that the base 30 is threaded into the opening 28 for coupling. In the initial configuration, the base 30 is threaded into the opening 28 with the key 16 directed into the pouch 24. As shown in FIG. 5, to use the refill unit 14, the key 16 is removed from the pouch 24, turned and coupled to the pouch 24 such that the key 16 is directed away from the pouch 24. In other configurations, the key 16 may be provided external to the pouch 24, separate from but attachable to the pouch 24, or in any other suitable fashion.

In a further embodiment, shown in FIG. 1b, the liquid dispenser 10 may have an indicator 11 indicating that it may be refilled with more than one variety of product. For example, the liquid dispenser 10 may have an indicator 11 indicating that the dispenser 10 may be refilled with a liquid soap having different fragrances such as lemon, orange, lavender, etc. A different key may be provided on the refill unit of each indicated soap. The lock 12 of the liquid dispenser 10 may be associated with the indicator 11 such that the indicator 11 and/or lock 12 may be adjusted such that the lock 12 receives the key of the soap being used to refill the liquid dispenser, and the indicator 11 indicates which soap is being used. In one embodiment, the indicator 11 is integral with the lock 12 such that the lock may be rotated to accept a particular soap for refilling the liquid dispenser 10 and such rotation indicates, for example via a pointer, what soap is being used to refill the liquid dispenser 10.

Associating different locks with different indications of the indicator may be done in any suitable manner. FIGS. 1b-1g illustrate one manner of association. As shown, the lock 12 is provided beneath the indicator 11. The lock 12 extends beyond the limits of the indicator 11 in each of its indicating positions. FIG. 1c illustrates the full lock 12. In each of the indicating positions of the indicator, a different configuration of the lock is revealed and a single key matches that configuration. Thus, FIG. 1d illustrates a key configuration for selecting lavender in FIG. 1b, FIG. 1e illustrates a key configuration for selecting orange in FIG. 1b, FIG. 1f illustrates a key configuration for selecting vanilla in FIG. 1b, and FIG. 1g illustrates a key configuration for selecting lemon in FIG. 1b. Any suitable manner of adjustable locks and keys may be used.

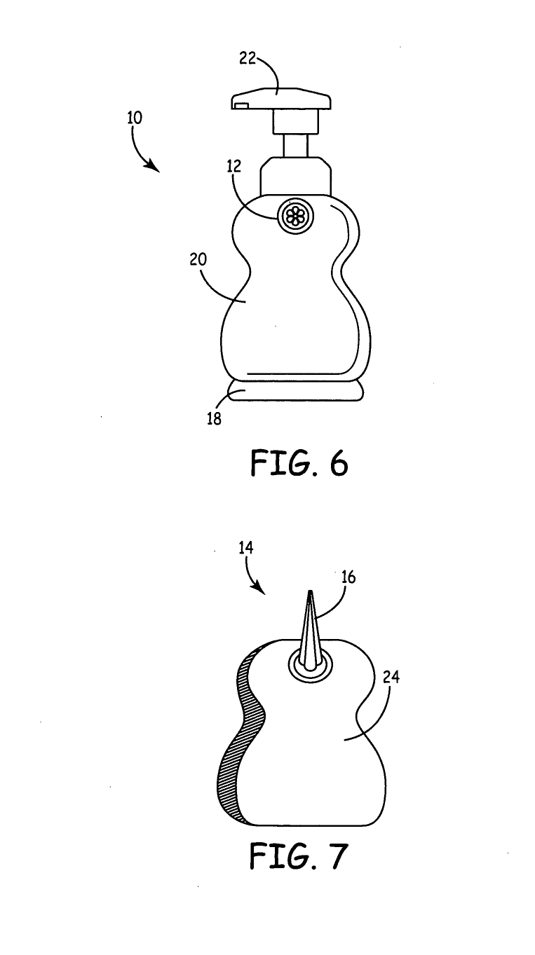

FIGS. 6 and 7 illustrate an alternative embodiment of a liquid dispenser 10 and associated refill unit 14. In the embodiment of FIGS. 6 and 7, the container and pouch have a more decorative shape than in the embodiment of FIGS. 1a and 2.

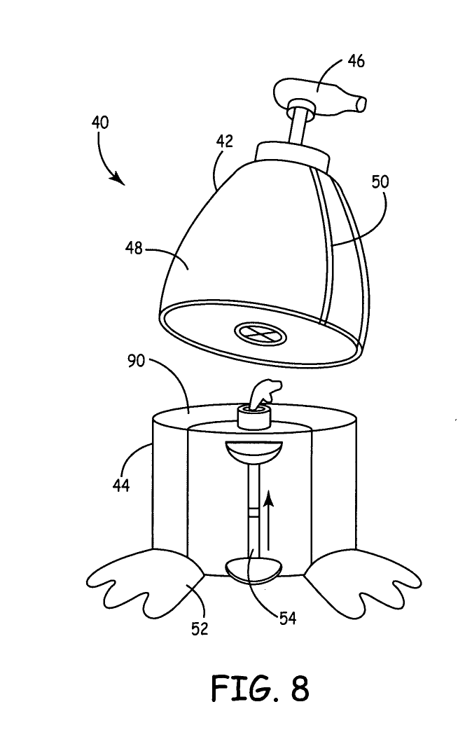

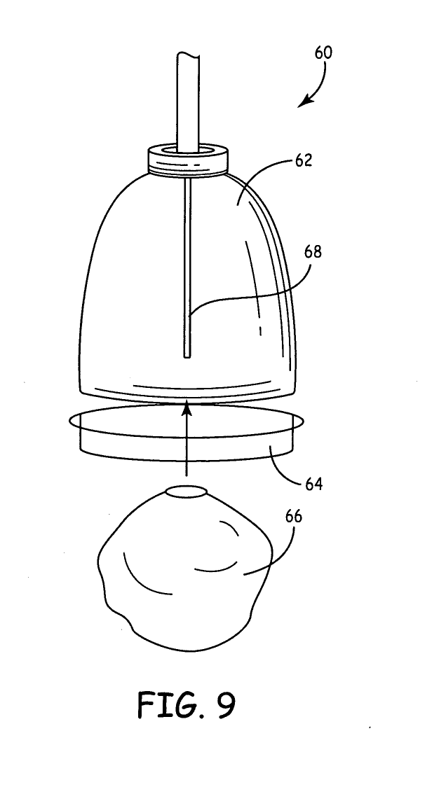

Alternative embodiments of a liquid dispenser and refill unit are shown in FIGS. 8 and 9. As shown in FIG. 8, the dispenser 40 includes a top portion 42 and a bottom portion 44. The top portion 42 may include a pump 46, an engagement aspect 48, and a visual indicator 50. The pump 46 may be a conventional pump, or any other suitable pump or structure, for a dispensing a liquid. Generally, the pump 46 includes a dipstick for insertion into the liquid to be dispensed. The bottom portion 44 includes a base 52 and a visual indicator 54, and is configured for receiving a refill unit 56. The refill unit 56 is shaped for placement and receipt in the bottom portion 44. The refill unit 56 may be at least partially transparent such that the visual indicator 54 of the bottom portion 44 of the dispenser 40 displays the liquid level in the refill unit 56. For use, the refill unit 56 is placed in the bottom portion 44 and the engagement aspect 48 of the top portion 42 is fit in the bottom portion 44 around the refill unit 56 with the pump dipstick extending into the refill unit 56. The visual indicator 50 of the top portion 42 may be aligned with the visual indicator 54 of the bottom portion 44 such that the refill unit 56 contents may be viewed. In alternative embodiments, no visual indicator is provided. A locking connection may be provided between the top portion and the bottom portion. A seal may be provided with the refill unit 56 such that the contents of the refill unit 56 are not accidentally dispensed. Further, an engagement aspect may be provided on the refill unit 56 for engaging the dipstick of the pump 46.

FIG. 9 shows an alternative embodiment, in which the dispenser 60 includes a top portion 62 and a base 64. The top portion 62 includes a pump. The pump may be a conventional pump, or any other suitable pump or structure, for a dispensing a liquid. Generally, the pump includes a dipstick for insertion into the liquid to be dispensed. The top portion 62 removably couples to the base 64, for example via a snap-fit, threaded, or other connection. The refill unit 66 is configured for placement on the base 64 and receipt by the top portion 62. For use, the top portion 62 is removed from the base 64, the refill unit 66 is placed on the base 64, the dipstick of the pump is inserted into the refill unit 66, and the top portion 62 is coupled to the base 64. A visual indicator 68 may be provided on the top portion for displaying the level of contents in the refill unit 66.

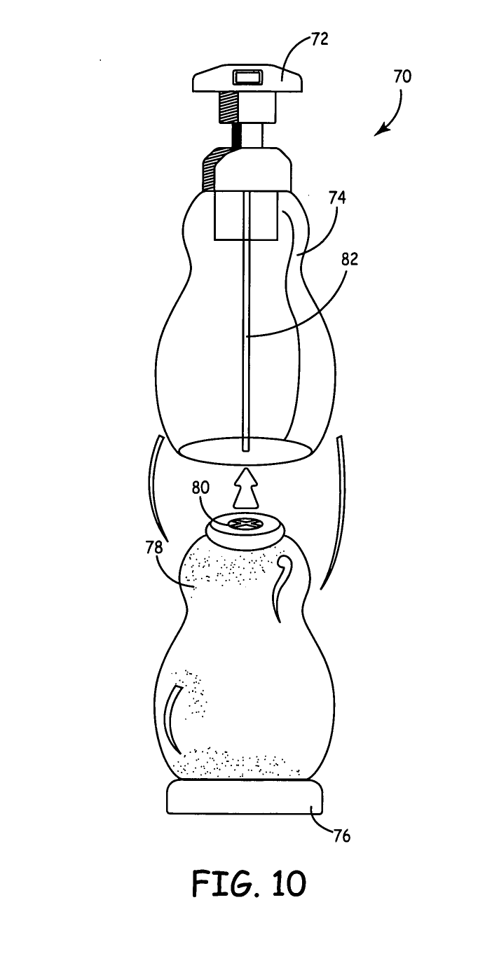

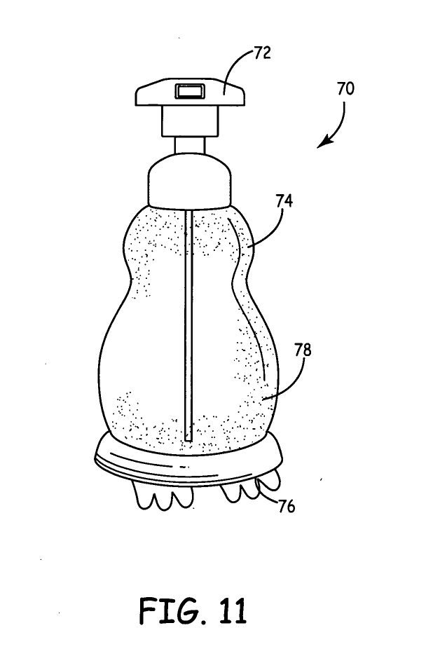

FIGS. 10 and 11 illustrate an embodiment of a liquid dispenser and associated refill unit wherein the liquid dispenser and refill unit have generally complementary configurations. The dispenser 70 includes a pump 72, a container 74, and a base 76. The pump 72 may be a conventional pump, or any other suitable pump or structure, for a dispensing a liquid. Generally, the pump 72 includes a dipstick 82 for insertion into the liquid to be dispensed. In some embodiments, the pump 72 may be permanently coupled to the container 74 such that the container is not refillable through an orifice typically filled by the pump 72. In alternative embodiments, the pump 72 may be removable from the container 74 via, for example, a threaded connection. The base 76 is removably coupled to the container 74. Such coupling may be provided in any suitable manner. For example, the coupling may be a snap-fit connection, a threaded connection, or other.

The refill unit 78 includes a sealed opening 80 at a top portion thereof and a coupling mechanism at a bottom portion thereof. The sealed opening 80 is unsealed for use with the liquid dispenser 70. Such unsealing may comprise, for example, puncturing a seal of the sealed opening 80. Alternatively, a seal, such as a removable seal, may be provided over the opening and removed for unsealing. The removable seal may be secured with an adhesive, tear-away, or other suitable connection. Other embodiments of a seal alternatively may be used. The refill unit 78 is removably coupled to the base. Such coupling may be provided in any suitable manner and may be, for example, a snap-fit connection, a threaded connection, or another suitable connection.

For use, the container 74 is removed from the base 76, and the refill unit 78 is coupled to the base 76 and unsealed. The container 74 is then fit over the refill unit 78 and coupled to the base 76 with the pump dipstick 82 extending into the refill unit 78. The container 74 may be transparent such that decoration provided on the refill unit 78 is apparent through the container 74. Alternatively, the container 74 may be opaque, translucent, or any combination of transparent, opaque, and translucent. In one embodiment, the container 74 is generally hard or inflexible while the refill unit 78 is generally flexible, such that the refill unit 78 shapes to the container 74 as the container 74 is fit thereover. The refill unit 78 or the container 74 may be provided with a visual indicator such as a window to indicate the level of liquid within the refill unit.

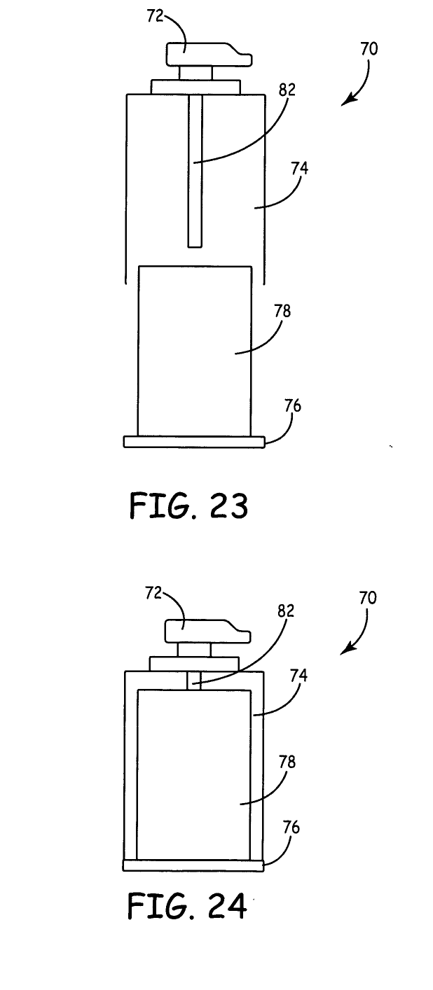

In an alternative embodiment to the embodiment of FIGS. 10 and 11, the refill unit and container of the dispenser may be shaped generally without curved sides, as shown in FIGS. 23 and 24. In this embodiment, the dispenser is fit over the refill unit with the dipstick of the pump extending into the refill unit. The container may be transparent with the refill unit having a visual design, the container may be opaque and have a visual design, both the container and the refill unit may be transparent such that the contents of the refill unit may be observed, one or more of the container and refill unit may be translucent, or any combination of the above may be used. The container and refill unit each may be any desired level of rigidity.

Similarly, the liquid dispenser and associated refill unit may have a common design theme or common design elements. Such design may comprise labeling and indicia. Alternately, such design may comprise configurations such as common packaging shapes. Further, the refill may be designed to reflect the refill concept. For example, the refill may be configured as a tank with a hose key to refill the liquid dispenser.

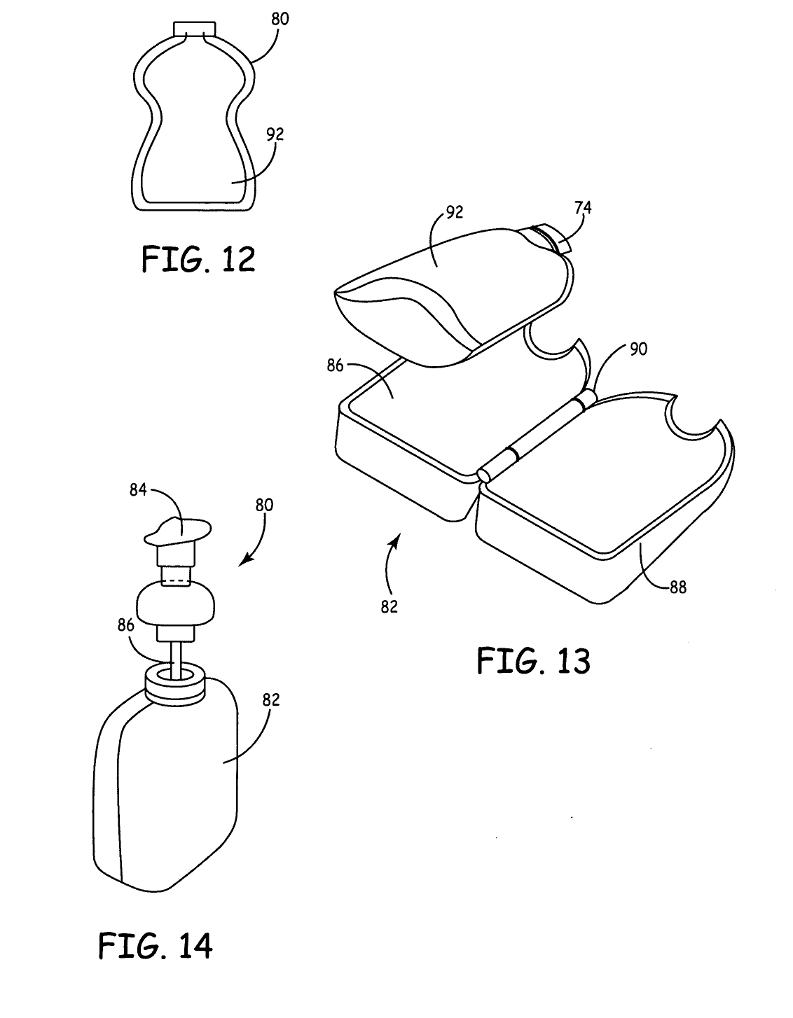

FIGS. 12-14 illustrate an alternative embodiment of a liquid dispenser and associated refill unit wherein the liquid dispenser and refill unit have complementary configurations such that the liquid dispenser is generally only refillable by receipt of the refill unit. As shown in FIG. 14, the dispenser 80 includes a container 82 and a pump 84. The pump 84 may be a conventional pump, or any suitable pump or dispenser, for a dispensing a liquid. Generally, the pump 84 includes a dipstick 86 for insertion into the liquid to be dispensed. The pump 84 may be coupled to the container 82, for example via a threaded connection. As shown in FIG. 13, the container 82 has a clamshell design, thus comprising a front portion 86 and a back portion 88, the front portion 86 being coupled to the back portion 88 along a pivoting side 90. The pivot point may be provided in any suitable manner. Alternatively, the front portion 86 and back portion 88 may be attached to one another in any suitable manner, such as by sliding, by snap fit, or by any other suitable fastening mechanism.

The shape of the liquid dispenser 80 and the refill unit 92 may vary. The shapes of each may or may not be generally complementary to the other. Where the shapes are not generally complementary, the refill unit 92 may be suspended within the liquid dispenser 80, such as by the neck of the liquid dispenser 80 or as held in place by tabs or protrusions. FIG. 12 and FIGS. 13 and 14 illustrate alternative shapes. Any suitable combination of shapes may be used.

The refill unit 92 may include a sealed opening 94 at a top portion thereof and be shaped for receipt by the clamshell of the container 82. The sealed opening 94 is unsealed for use with the liquid dispenser. Such unsealing may comprise, for example, puncturing a seal of the sealed opening, removing a removable seal, etc. In yet an alternative embodiment, the sealed opening may comprise a capped opening wherein unsealing comprises removing the cap. Other embodiments of a seal may alternatively be used. In use, the clamshell of the container 82 is opened and the refill unit 92 is placed therein. With the dispenser 80 in an upright configuration, the seal 94 of the refill unit 92 is removed. Alternatively, the seal 94 of the refill unit 92 may be removed before placement into the container 82. The dipstick 86 of the pump 84 is inserted into the refill unit 92 and the pump 84 is coupled to the container 82.

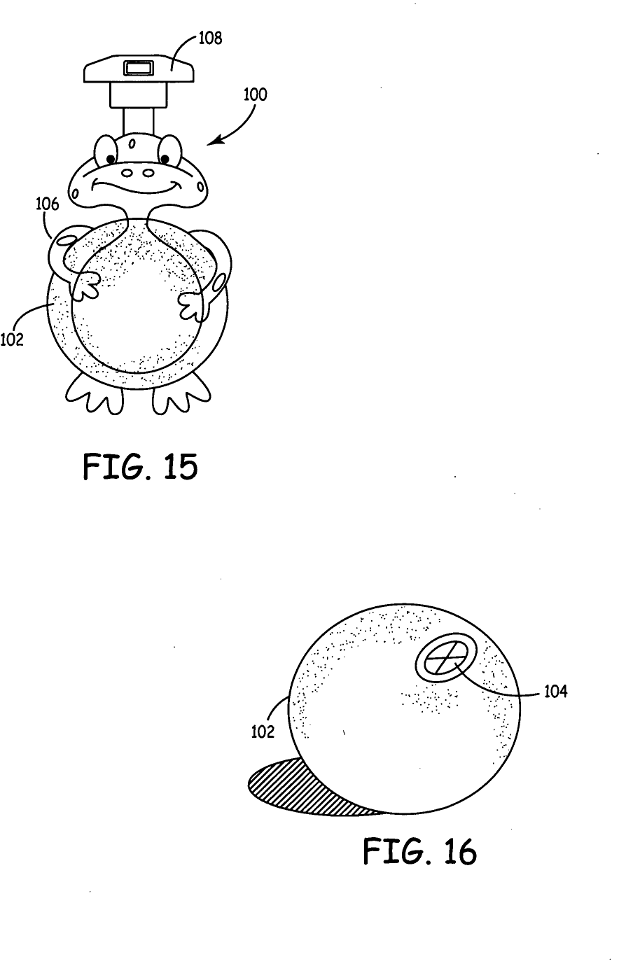

FIGS. 15 and 16 illustrate yet a further embodiment of a liquid dispenser and associated refill unit. In the embodiment shown, the refill unit 102 has a complementary shape to the dispenser 100 and has a configuration related to a design aspect of the dispenser 100. Thus, the liquid dispenser 100 may have a theme and the refill unit 102 may complement that theme. The liquid dispenser comprises a holding portion 106 and a pump 108. In one embodiment shown, the liquid dispenser 100 may be shaped as an animal, such as a frog. The refill unit 102 may be shaped as the stomach of the animal, and include a sealed opening 104 at a top portion thereof. The sealed opening 104 is unsealed for use with the liquid dispenser 100. Such unsealing may comprise, for example, puncturing a seal of the sealed opening. Alternatively, a seal such as an adhesively placed seal may be provided over the opening and removed for unsealing. Other embodiments of a seal may alternatively be used.

As shown, the refill unit 102 is fit into the holding portion 106 of the dispenser 100. The holding portion 106 may be, for example, fit into a space provided between the arms and the legs of the animal of the dispenser such that the arms and legs maintain the refill unit 102 in position. Alternatively, the refill unit 102 may be configured to represent any portion of the theme, such as the head of an animal. The seal 104 of the refill unit 102 is unsealed, before or after placement of the refill unit 102 into the dispenser 100, and the dipstick of the pump 108 is inserted therethrough. Immediately after the refill unit 102 is placed, the animal of the dispenser 100 appears full. As the refill unit 102 empties and it becomes necessary to replace the refill unit 102, the stomach becomes less full and visually appears “skinny.” This indicates to a child, for example, that it is time to refill the dispenser 102. Accordingly, in the embodiment of FIGS. 15 and 16, the refill unit 102 may comprise a flexible material that deforms as the contents of the refill unit 102 are removed. Alternatively, the refill unit 102 may be translucent or transparent, so that the contents are visually observable. The refill unit 102 also may be increasingly or decreasingly shaded in one or more directions, such as from top to bottom, so as signify when the refill unit 102 is getting low. Alternatively, the refill unit 102 may transition from transparency or translucency into less translucency or even opaqueness in one or more directions, such as from top to bottom, so as signify when the refill unit 102 is getting low.

The refill unit 102 may comprise a pouch that is inserted in the dispenser 100 and left in the dispenser 100 during use. When the refill unit 102 is emptied, the refill unit 102 may be removed from the dispenser 100 and disposed of. In some embodiments the pouch may be non-rigid.

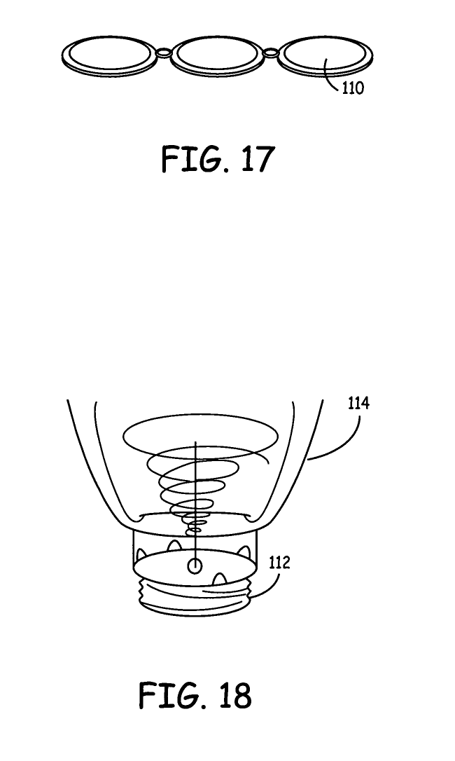

As shown in FIG. 17, a plurality of refills may be provided in linked containers or packets 110. The contents of each refill packet 110 may be transferred to a refill unit such as shown in FIGS. 2, 4, 7, or others. A mix-in such as a color, glitter, or other may be added to the refill unit, or it may be prepackaged into the various refill packets 110. Thus, the consumer can customize the refill liquid for the liquid dispenser. In such an embodiment, it may be useful for the refill unit to be transparent or translucent such that the consumer can view the customized refill liquid.

FIG. 18 illustrates one embodiment of the refill lock 112. In this embodiment, a close up of a refill lock 112, which may be provided with a refill unit 114, is shown. The lock 112 operates to couple the key to the refill unit 114 such that the key can be removed to fill the refill unit 114. As shown, the refill unit 114 tapers at the dispensing end. This may facilitate transfer of the refill liquid into the liquid dispenser.

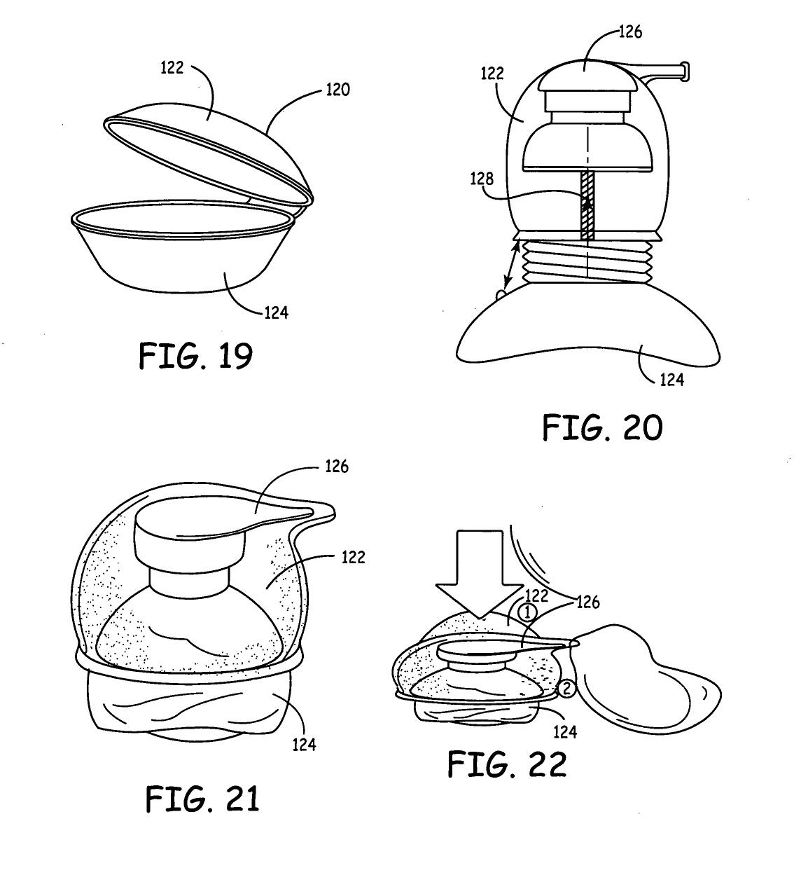

FIGS. 19-22 illustrate an alternative liquid dispenser and refill unit embodiment. In this embodiment, the refill unit 120 may form at least a portion of the dispensing unit and receive a pump 126. The refill unit 120 comprises a top portion 122 and a bottom portion 124. As shown in FIG. 19, the top portion 122 may be connected to the bottom portion 124, such as via a pivot point or other suitable connection. The pump 126 may be a conventional pump, or any suitable pump or mechanism, for a dispensing a liquid. Generally, the pump 126 includes a dipstick 128 for insertion into the liquid to be dispensed. The bottom portion 124 of the refill unit 120 stores the refill liquid for dispensing. The size and shape of the bottom portion 124 may vary as desired. Further, the bottom portion 124 may be flexible or substantially rigid. The pump 126 couples to the bottom portion 124, for example via a threaded connection, a snap-fit connection, or by any other suitable mechanism. The top portion 122 may comprise a flexible or malleable material, and it receives the pump 126. As shown, the top portion 122 may generally conform to the shape of the pump 126. Thus, for use, the top portion 122 may be separated from the bottom portion 124. This may be, for example, via a pivot point or a complete separation. The pump 126 is coupled to the bottom portion 124 with the dipstick 128 extending into the bottom portion 124. As can be appreciated, the bottom portion 124 may be any suitable size or shape for containing liquid to be dispensed. FIG. 20 illustrates the pump 126 being coupled to the bottom portion 124. A seal may be provided on the bottom portion 124 and removed prior to coupling of the pump 126 thereto. The top portion 122 may be replaced over the pump 126, as shown in FIG. 21. Alternatively, the pump 126 and bottom portion 124 may be used without the top portion 122. To dispense liquid, the top portion 122, the pump 126, or both may be depressed. Flexibility of the top portion 122 permits the top portion 122 to deform and the pump 126 thus to be depressed, as shown in FIG. 22.

Although the invention has been described with reference to preferred embodiments, persons skilled in the art will recognize that changes may be made in form and detail without departing from the spirit and scope of the invention.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. A liquid dispenser and refill unit comprising:
a liquid dispenser having a lock; and
a refill unit having a key;
wherein the liquid dispenser is refilled by fitting the key into the lock and
transferring contents of the refill unit into the liquid dispenser.

2. The liquid dispenser and refill unit of claim 1, wherein the liquid dispenser further comprises a pump.

3. The liquid dispenser and refill unit of claim 1, wherein the lock and key have complementary geometric configurations.

4. The liquid dispenser and refill unit of claim 3, wherein the lock and key are generally star-shaped.

5. The liquid dispenser and refill unit of claim 1, wherein the liquid dispenser is substantially rigid.

6. The liquid dispenser and refill unit of claim 1, wherein the refill unit is flexible.

7. The liquid dispenser and refill unit of claim 1, wherein the lock is provided at a top portion of the liquid dispenser.

8. The liquid dispenser and refill unit of claim 1, wherein the pump is nonremovably coupled to the liquid dispenser.

9. The liquid dispenser and refill unit of claim 1, wherein the liquid dispenser includes a rigid base.

10. The liquid dispenser and refill unit of claim 1, wherein the refill unit includes a rigid base.

11. The liquid dispenser and refill unit of claim 1, wherein the refill unit is refillable.

12. The liquid dispenser and refill unit of claim 1, wherein a dipstick of the pump is inserted into the lock and wherein the dipstick is configured as a key.

13. A liquid dispenser and refill unit comprising:
a liquid dispenser, the liquid dispenser comprising a container and a pump, the pump having a dipstick; and
a refill unit configured for receipt by the container of the liquid dispenser;
wherein the liquid dispenser is refilled by fitting the refill unit into the container and extending the dipstick into the refill unit.

14. The liquid dispenser and refill unit of claim 13, wherein the liquid dispenser includes a top portion and a bottom portion, the top portion being received by the bottom portion, wherein the bottom portion forms the container and the refill unit is placed in the bottom portion.

15. The liquid dispenser and refill unit of claim 14, wherein at least one of the top portion or the bottom portion includes a visual indicator.

16. The liquid dispenser and refill unit of claim 15, wherein said visual indicator is in the form of a dial which can be used to identify one of a plurality of variations of liquid offered for dispensing.

17. The liquid dispenser and refill unit of claim 13, wherein the container is substantially rigid and the refill unit is flexible.

18. The liquid dispenser and refill unit of claim 13, wherein the refill unit comprises a seal.

19. The liquid dispenser and refill unit of claim 13, wherein the liquid dispenser further comprises a base, and wherein the container may be coupled to the base.

20. The liquid dispenser and refill unit of claim 13, wherein the container has a clamshell design.

21. The liquid dispenser and refill unit of claim 13, wherein the liquid dispenser has a theme and the refill unit complements the theme.

22. The liquid dispenser and refill unit of claim 21, wherein the liquid dispenser is formed as an animal and the refill unit is formed as part of the animal.

23. A liquid dispenser and refill unit comprising:
a pump having a dipstick; and
a refill unit comprising a flexible top portion and a bottom portion;
wherein the pump is received by the top portion with the dipstick extending into the bottom portion.
